(19) United States
(12) Patent Application Publication
(10) Pub. No.: US 2016/0121423 A1
(43) Pub. Date: May 5, 2016

(54) TIG WELDING TORCH

(71) Applicant: Fronius International GmbH, Pettenbach (AT)

(72) Inventors: Manfred HUBINGER, Kremsmuenster (AT); Josef LEEB, Pettenbach (AT); Stefan PUEHRINGER, Vorchdorf (AT)

(73) Assignee: FRONIUS INTERNATIONAL GMBH, Pettenbach (AT)

(21) Appl. No.: 14/930,908

(22) Filed: Nov. 3, 2015

(30) Foreign Application Priority Data
Nov. 4, 2014 (AT) A 50803/2014

(51) Int. Cl. B23K 9/29; B23K 9/12

(52) U.S. Cl. CPC B23K 9/296; B23K 9/126

(57) ABSTRACT

The invention relates to a TIG welding torch (1) comprising a torch head (2) with at least one non-melting electrode (3) and at least one feeder device (4) for a melting wire-shaped filler material (5), wherein the longitudinal axis of each electrode (3) and the longitudinal axis of each wire-shaped filler material (5) intersect each other in a Tool Center Point (TCP), and wherein the torch head (2) is arranged adjustably on a support (6) and is adapted to be fixed in at least two different positions while the Tool Center Point (TCP) remains the same. For achieving a compact construction and higher flexibility during welding, the support (6) is of elongate and quasi V-shaped design and comprises a circular guide (7) at the front end thereof, in which guide (7) a slide (8) connected with the torch head (2) is adapted to be arranged, so that the outer dimensions of the torch head (2) are not changed substantially in the case of an adjustment of the torch head (2).

The invention relates to a TIG welding torch comprising a torch head with at least one non-melting electrode and at least one feeder device for a melting wire-shaped filler material, wherein the longitudinal axis of each electrode and the longitudinal axis of each wire-shaped filler material intersect each other in a Tool Center Point (TCP), and wherein the torch head is adjustably mounted on a support and is adapted to be fixed in at least two different positions while the Tool Center Point (TCP) remains the same.

TIG (tungsten inert gas) welding torches comprise at least one, preferably two, non-melting temperature-resistant tungsten electrodes for forming an arc burning between the electrodes and the workpiece to be processed. The material for filling a gap between two work pieces or for being applied on the surface of the workpiece during the so-called deposition welding is supplied by means of a wire-shaped filler material which is introduced into the arc where heating and liquefaction of the filler material takes place. During the feeding of different materials, a plurality of wire-shaped filler materials may also be conveyed to the welding torch. The at least one non-melting electrode is surrounded by the torch head with the torch nozzle, into which the protective gas (argon, helium or the like) which is usually used for welding is also fed, so that the ignition properties and the stability of the arc may be optimized. The power supply required for igniting the arc is effected via appropriate cables to the torch head and/or the electrodes. The at least one wire-shaped filler material intersects the arc in the so-called Tool Center Point (TCP). When using different torch heads or pipe elbows, care is taken that this Tool Center Point always remains the same, so that an adjustment of the feeder device for the melting wire-shaped filler material is not necessary if the torch head and/or the pipe elbow is changed.

U.S. Pat. No. 7,329,827 B2, for instance, describes a TIG welding torch of the generic type which has relatively large dimensions, so that welding, in particular deposition welding, is not possible for all workpiece geometries. Such a welding torch is, for instance, not suited for deposition welding in the interior of tubes, such as it is performed during the so-called cladding e.g. with boiler tubes or pipelines. Such a cladding method is, for instance, performed for the purpose of protection from corrosion and abrasion in that particular more resistant materials are applied onto the inner surface of such tubes.

CN 102825368 A describes a TIG welding torch of the generic type which comprises an adjustable torch head. The construction is relatively complex and large, so that it is not suited for the welding of all workpiece geometries, in particular not for deposition welding in the interior of tubes.

The object of the present invention consists in providing an above-mentioned welding torch which is of preferably small design size and which enables moreover an optimum use with differently shaped work pieces. Disadvantages of known TIG welding torches are intended to be avoided or at least reduced.

This object is solved in that the support is of elongate and quasi V-shaped design and comprises a circular guide at the front end thereof, in which guide a slide connected with the torch head is adapted to be arranged, so that the outer dimensions of the torch head are not changed substantially in the case of an adjustment of the torch head. Due to the adjustability of the torch head in at least two, preferably more, positions it is easier to perform a simple adaptation of the TIG welding torch to the respective circumstances, for instance, during deposition welding in the interior of a tube, without the necessity of exchanging the TIG welding torch or the torch head thereof. The adjustability of the torch head on the support of the TIG welding torch ensures a constant Tool Center Point, so that the at least one feeder device for the melting wire-shaped filler material need not be adjusted if the position of the torch head is changed. Thus, it is possible to perform a refitting of the TIG welding torch and/or an adjustment of the torch head in a very quick and simple manner without the welding process being interrupted for a long time. The support for the torch head is formed by a circular guide in which a slide connected with the torch head is adapted to be arranged. Such a construction of the support enables a very simple adjustability of the torch head in that it is fastened to a slide of appropriate design and the slide is arranged at the desired position in the circular guide. The slide may be adapted to the shape of the respective torch head. In the TIG welding torch according to the invention, the Tool Center Point is positioned laterally of the longitudinal axis of the welding torch or the elongate quasi V-shaped support. The Tool Center Point (TCP) is positioned on the extension of the central axis (symmetry axis) of the torch head, wherein the central axis intersects the longitudinal axis of the welding torch laterally of the support. The central axis of the support is accordingly adjustable in accordance with the angle α in the plane spanned by the longitudinal axis and the central axis. Thus, in the case of the welding torch according to the invention, the Tool Center Point (TCP) is positioned outside of the longitudinal axis or the longitudinal extension of the welding torch or the support. This space-saving construction yields particular advantages as compared to conventional constructions of such welding torches, said advantages enabling even the welding of more complex geometries, in particular deposition welding in the interior of tubes, such as boiler tubes or pipelines, in an optimum manner.

Preferably, the torch head is arranged to be continuously adjustable on the support. In the case of a continuous adjustability of the torch head on the support it is possible to create an optimum angle of the torch head relative to the at least one wire-shaped filler material and the workpiece to be processed. For instance, it is possible to perform both horizontal and vertical welding processes with such a TIG welding torch by changing the position of the torch head appropriately.

The circular guide encompasses an angular range of 45° to 120°, preferably 90°. Due to such an angular range it is possible to optimally implement most positions of the torch head relative to the workpiece and hence most welding methods or welding positions.

Advantageously, fixing elements for fixing the slide at the respective desired position in the guide are provided. Such fixing elements may, for instance, be produced in a very simple and cost-efficient manner by means of clamping screws or the like.

If a device for fastening the at least one feeder device for the wire-shaped filler material is arranged on the support, it is possible to achieve an optimum observance of the Tool Center Point (TCP). The fastening device for the at least one feeder device for the wire-shaped filler material is arranged at an appropriate position of the support of the TIG welding torch, so that the adjustability of the torch head is not impeded. The fastening device may, for instance, be arranged on an appropriately designed bow of the support at the opposite side of the support, so that the torch head is arranged substantially between the support and the at least one feeder device for the wire-shaped filler material. Alternatively, the fastening device may also be mounted on a torch body.

The fastening device is preferably arranged adjustably on the support, so that the Tool Center Point (TCP) may be adjusted or readjusted. Adjustability may, for instance, be implemented in a simple and cost-efficient manner by means of screws arranged in long holes.

In accordance with a further feature of the invention the fastening device is formed by a cuboid in which the feeder device for the wire-shaped filler material may be arranged. This constitutes a simple and cost-efficient implementation of the fastening device. It is to be understood that the support may also be formed integrally with the fastening device for the at least one feeder device for the wire-shaped filler material.

The at least one feeder device for the wire-shaped filler material may be formed by a tube of a deformable material, for instance, copper. This constitutes a simple and flexible variant of implementation.

The support for the torch head is usually connected with a torch body which is in turn connected with the usual hose package comprising the necessary cables and lines from the welding power source to the welding torch or the torch head. The torch body is usually. fastened to appropriate automated facilities, such as a rotating device, so that a continuous rotation of the welding torch is enabled. The torch body may also be fastened to a manipulator of a welding robot.

The embodiment of the TIG welding torch according to the invention is characterized by a space-saving construction which facilitates or enables in particular the deposition welding in the interior of hollow work pieces, for instance, tubes. The adjustment of the torch head is preferably performed such that the outer dimensions of the welding torch are not changed substantially during the adjustment of the torch head. Preferably, the outer dimensions of the TIG welding torch are determined by the diameter of the torch head.

The invention will be explained in more detail by means of the enclosed drawings which illustrate an embodiment.

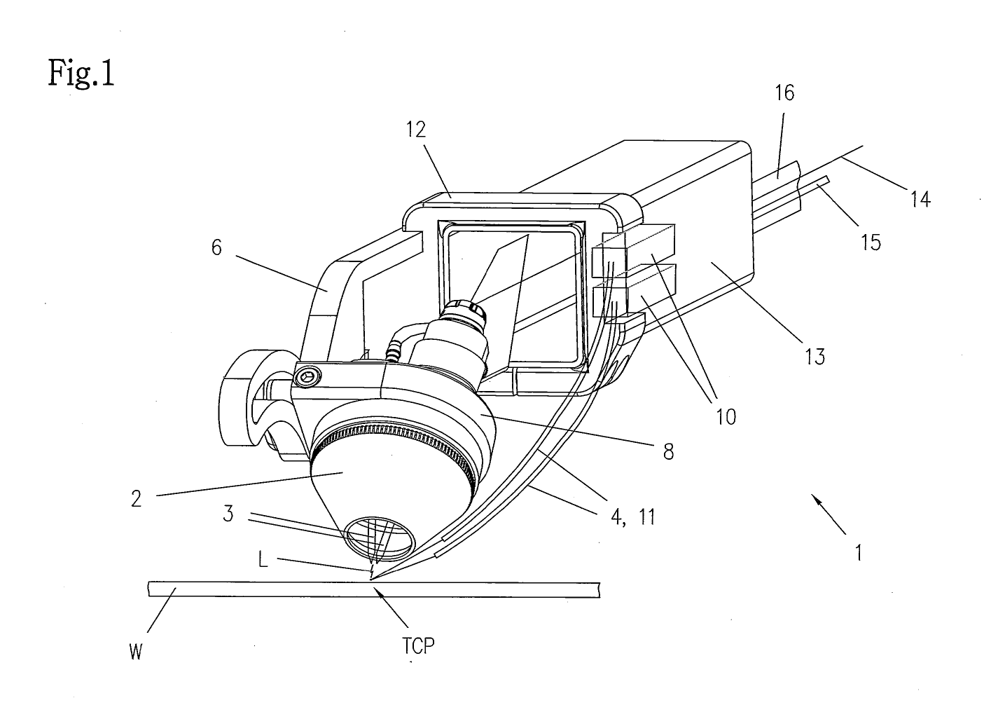

FIG. 1 shows a perspective view of an embodiment of a TIG welding torch;

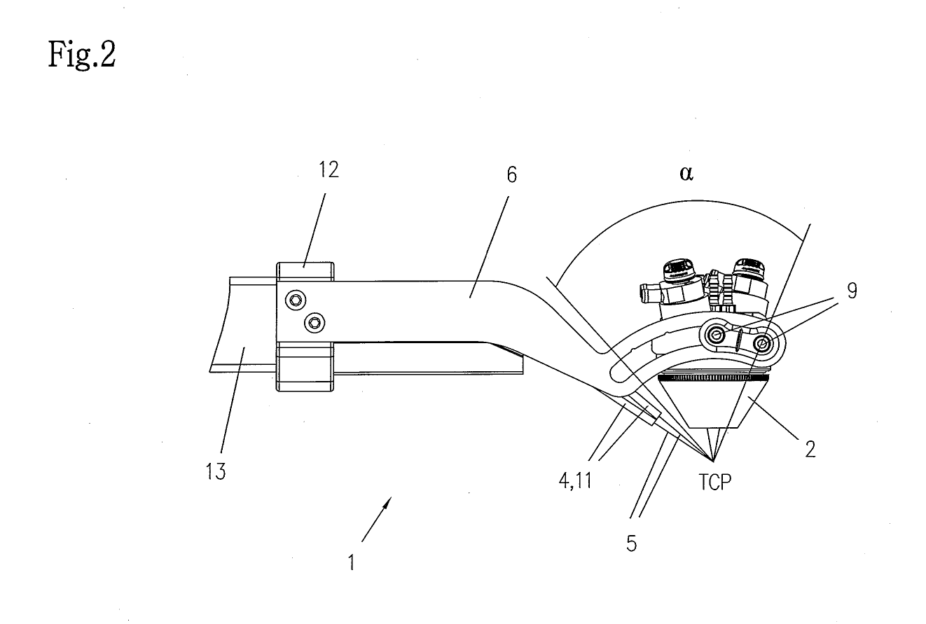

FIG. 2 shows a side view of the TIG welding torch according to FIG. 1 with a first position of the torch head; and

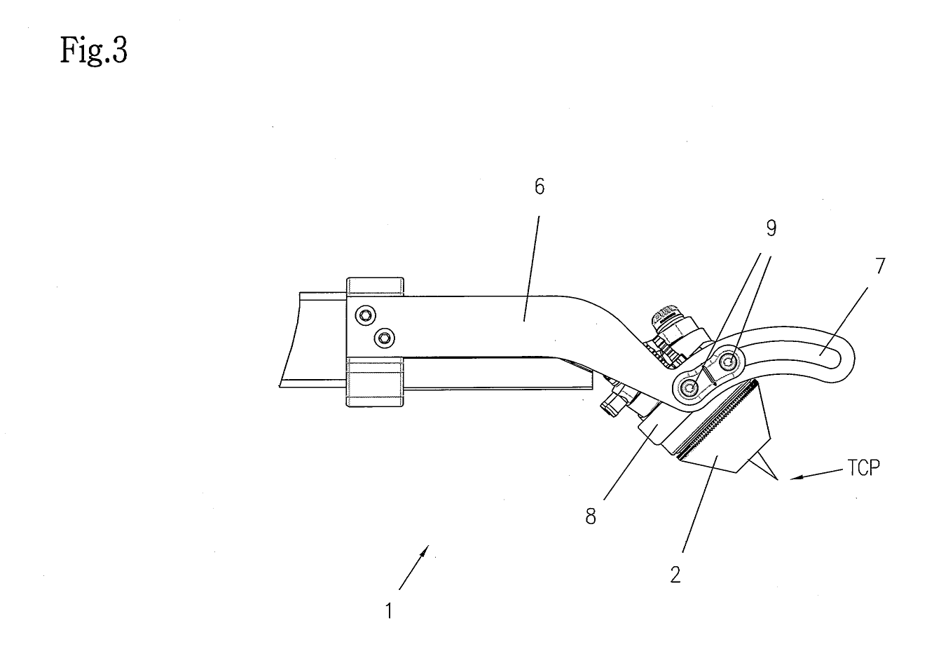

FIG. 3 shows a side view of the TIG welding torch according to FIG. 2 with an adjusted welding torch.

FIG. 1 illustrates a perspective view of an embodiment of a TIG welding torch 1. The TIG welding torch 1 comprises a torch head 2 in which at least one, preferably two, non-melting electrodes 3, preferably of tungsten, are arranged. The non-melting electrodes 3 are connected with the welding power source (not illustrated) by appropriate cables 14 to be able to supply the electrodes 3 with appropriate current. Via a gas supply line 15 the commonly used protective gas (argon, helium, or the like) is conveyed to the welding point. Between the at least one non-melting electrode 3 and the workpiece W to be processed, the arc L is ignited which melts at least one wire-shaped filler material 5 conveyed via a feeder device 4 in a Tool Center Point (TCP), so that this molten filler material 5 is applied onto the surface of the workpiece W, for instance, during deposition welding. The longitudinal axis of each electrode 3 and the longitudinal axis of each wire-shaped filler material 5 intersect each other in this Tool Center Point (TCP). In accordance with the invention it is now provided that the torch head 2 of the TIG welding torch 1 is arranged adjustably on a support 6 and is adapted to be fixed in at least two different positions, preferably a plurality of positions, at best continuously, while the Tool Center Point (TCP) remains the same. Likewise, if the torch head 2 is adjusted, the position of the tips of the electrodes 3 or the position of the center between the tips of a plurality of electrodes 3 may remain the same. At the end of each support 6 a channel may be arranged which extends inside the torch body 13 and then turns into the hose package 16 connected with the torch body 13. Furthermore, cooling lines for guiding a cooling fluid for cooling the TIG welding torch 1 may be contained in the hose package 16.

In a joint view with FIGS. 2 and 3, an embodiment of the TIG welding torch 1 consists of an elongate quasi V-shaped support 6 comprising a circular guide 7 at the front end thereof, in which guide a slide 8 connected with the torch head 2 is adapted to be arranged, so that an adjustability of the torch head 2 in an angle range α of approximately 60° is possible, while the Tool Center Point (TCP) remains the same. With an appropriate design of the guide 7 a larger angular range a may also be achieved. The at least one feeder device 4 for the wire-shaped filler material 5 is arranged at the opposite side of the support 6, so that the position of the torch head 2 may be adjusted freely without the feeder device 4 and hence the Tool Center Point (TCP) having to be changed. The fixing of the torch head 2 in the desired position is preferably performed by means of fixing elements 9 such as screws. While the torch head 2 is adjusted, the TCP remains always the same, so that the change may be performed in a simple and quick manner and the TCP does not have to be adjusted newly. The feeder device 4 for the wire-shaped filler material 5 may be formed by a tube 11 of a deformable material, for instance, copper. Thus, it is possible to convey the wire-shaped filler material 5 to the TCP in an optimum manner and with as little friction as possible. A device 12 for fastening the at least one feeder device 4 for the wire-shaped filler material 5 is arranged at the support 6 or at the torch body 13. This device 12 for fastening the feeder device 4 may, for instance, comprise a cuboid 10 in which the feeder device 4 is arranged in the form of a tube 11. If the cuboid 10 is arranged pivotally in the profile-shaped fastening device 12, an optimum, almost friction-less conveyance of the wire-shaped filler material 5 in the feeder device 4 may be ensured.

The TIG welding torch 1 thus enables a simple and quick change of position of the torch head 2 for different welding methods and/or welding positions, in particular in the interior of tubes during deposition welding. A change of the position of the TIG welding torch 1 is in particular relevant if the inner diameter of a tube-shaped workpiece, for instance, tapers conically or reduces step-wise.

The TIG welding torch 1 is characterized by a very compact and space-saving construction and enables, due to the adjustability of the torch head 2, both horizontal and vertical welding without changing the TIG welding torch .1 by merely changing the position of the torch head 2.

1. A TIG welding torch (1) comprising a torch head (2) with at least one non-melting electrode (3) and at least one feeder device (4) for a melting wire-shaped filler material (5), wherein the longitudinal axis of each electrode (3) and the longitudinal axis of each wire-shaped filler material (5) intersect each other in a Tool Center Point (TCP), and wherein the torch head (2) is arranged adjustably on a support (6) and is adapted to be fixed in at least two different positions while the Tool Center Point (TCP) remains the same, wherein the support (6) is of elongate and quasi V-shaped design and comprises a circular guide (7) at the front end thereof, in which guide (7) a slide (8) connected with the torch head (2) is adapted to be arranged, so that the outer dimensions of the torch head (2) are not changed substantially in the case of an adjustment of the torch head (2).

2. The TIG welding torch (1) according to claim 1, wherein the torch head (2) is arranged to be continuously adjustable on the support (6).

3. The TIG welding torch (1) according to claim 1, wherein the circular guide (7) encompasses an angular range (α) of 45° to 120°, preferably 90°.

4. The TIG welding torch (1) according to claim 1, wherein fixing elements (9) are provided for fixing the slide (8) in the guide (7).

5. The TIG welding torch (1) according to claim 1, wherein a device (12) for fastening the at least one feeder device (4) for the wire-shaped filler material (5) is arranged preferably on the support (6).

6. The TIG welding torch (1) according to claim 5, wherein the fastening device (12) is arranged adjustably on the support (6).

7. The TIG welding torch (1) according to claim 5, wherein the fastening device (12) is formed by a cuboid (10) in which the feeder device (4) for the wire-shaped filler material (5) may be arranged.

8. The TIG welding torch (1) according to claim 1, wherein the at least one feeder device (4) for the wire-shaped filler material (5) is formed by a tube (11) of a deformable material, for instance, copper.

9. The TIG welding torch (1) according to claim 1, wherein the support (6) for the torch head (2) is connected with a torch body (13).
